(19) United States
(12) Patent Application Publication
(10) Pub. No.: US 2020/0053405 A1
(43) Pub. Date: Feb. 13, 2020

(54) DETERMINISTIC VIEWER ASSIGNMENT MODEL

(71) Applicant: comScore, Inc., Reston, VA (US)

(72) Inventors: Ying Li, Falls Church, VA (US); Frank E. Pecjak, Fairfax, VA (US)

(21) Appl. No.: 16/100,356

(22) Filed: Aug. 10, 2018

(51) Int. Cl. H04N 21/258; H04N 21/466; G06F 17/18

(52) U.S. Cl. CPC H04N 21/25883; G06F 17/18; H04N 21/4661

(57) ABSTRACT

Techniques for generating a deterministic outcome for content viewership based on a probability model are described. Information that identifies a probability that a particular portion of a program was viewed by an individual member of a household may be accessed. A probability distribution may be generated that represents, for each of a plurality of state spaces, a probability that the particular portion of the program was viewed by the plurality of individual members of the household. Based on a simulation of the generated probability distribution, a plurality of possible viewership scenarios may be determined. One of the plurality of viewership scenarios may be selected, and a report may be generated that identifies, for the selected viewership scenario, each of the individual members of the household and an indication of whether the particular portion of the program was viewed by each of the individual members of the household.

### TECHNICAL FIELD

The present disclosure generally relates to systems and methods for determining program viewership, and more particularly to systems and methods for generating a deterministic outcome for content viewership based on a probability model.

### BACKGROUND

Television advertising relies on program and network viewership data in order to determine the expected reach of advertising slots. Advertisers are interested in numbers of viewers as well as the demographics of viewers in order to effectively manage television advertising timing and content. Understanding television audience viewing and habits may be useful in supporting planning, buying, and selling advertising.

### SUMMARY

Techniques for generating a deterministic outcome for content viewership based on a probability model are described. Initially, household member data that identifies a plurality of individual members of a household may be accessed. Information that identifies, for each of the plurality of individual members of the household, a probability that a particular portion of a program was viewed by that individual member of the household may also be accessed. A plurality of state spaces may be generated, each of the plurality of state spaces indicating whether or not the particular portion of the program was viewed by each of the plurality of individual members of the household. In addition, a probability distribution may be generated that represents, for each of the plurality of state spaces, a probability that the particular portion of the program was viewed by the plurality of individual members of the household represented by the state space.

Based on a simulation (e.g., a Monte Carlo simulation) of the generated probability distribution, a plurality of possible viewership scenarios may be determined, each of the plurality of possible viewership scenarios corresponding to one of the state spaces. Then, one of the plurality of viewership scenarios may be selected, and a report may be generated that identifies, for the selected viewership scenario, each of the individual members of the household and an indication of whether the particular portion of the program was viewed by each of the individual members of the household.

Implementations of any of the described techniques may include a method or process, an apparatus, a device, a machine, a system, or instructions stored on a computer-readable storage device. The details of particular implementations are set forth in the accompanying drawings and description below. Other features will be apparent from the following description, including the drawings, and the claims.

### BRIEF DESCRIPTION OF THE DRAWINGS

FIG. 1 illustrates an example system in which television viewership information may be collected and processed to determine audience measurement data.

FIG. 2 illustrates an example system in which person-level viewing data can be used to project person-level viewership data for a household from household-level tuning data through demographic attribution.

FIG. 3 is a flow diagram illustrating an example process for determining a plurality of state values associated with panelist viewing data.

FIG. 4 illustrates an example system in which television viewership information may be collected and processed to determine audience measurement data for non-rostered households.

FIG. 5 is a flow diagram illustrating an example process for generating a report indicative of a probability that an individual household member will watch a portion of a program.

FIG. 6 is a flow diagram illustrating an example process for generating a report that contains a deterministic outcome for content viewership for a plurality of household members.

FIG. 7 illustrates an example Venn diagram representing a plurality of state spaces for content viewership for a plurality of household members.

### DETAILED DESCRIPTION

Estimates of program viewership may be used by content providers, advertisers, and others to estimate the number of people that viewed a particular program, advertisement, sporting event, or other content item. The content may be viewed on a television (TV), tablet, mobile phone, or other electronic device. Viewership data can be collected at multiple levels. For example, person-level television viewership may be measured for a set of viewers, referred to as “panelists,” who, in some cases, have agreed to have their viewing behavior monitored. For example, the measured viewership may be used for the purposes of producing viewing estimates. Each panelist may be associated with demographic information, such as, for example, the gender of the panelist, the age of the panelist, the income of the panelist, a geographic area in which the panelist lives, a size of the panelist's household, and other information.

In some cases, each panelist may be given a monitoring device to keep on their person, which monitors audio signals to determine if the panelist is watching a television program, and identifies the television program being watched. For example, the monitoring device may detect encoded signals within the television program audio identifying the television program. The monitoring device may also identify the television program from the detected audio by other mechanisms, such as, for example, by generating an acoustic fingerprint for the detected audio and consulting a database mapping acoustic fingerprints to television programs. Viewership data for the panelists, or “person-level data,” may be collected from the monitoring devices (e.g., by transferring the data to an external server over a network such as the Internet), and may be further analyzed to determine statistics, trends, and other information regarding viewership of television programs. In some cases, the person-level data may be used to project viewership statistics for larger populations, such as the total number of viewers or viewing minutes for a television program for a particular demographic or a particular geographic area. However, collecting person-level data from panelists is logistically complex, and thus the sample size of the person-level data may be small, leading to a large margin of error in projections of viewership data for larger populations.

Television viewership can also be measured at the household level, such as, for example, by a set-top-box logging viewing activity. This “household-level data” may be easier to obtain for a large sample of viewers, but may not provide any information regarding which members of the household (if any) watched a particular television program. It may be difficult to accurately project individual viewership numbers (e.g., the number of unique individual viewers for the particular program) from this household-level data, which, as stated, may not include any information regarding which members of the household (if any) watched the particular television program.

Typically, viewership data is estimated to determine a probability that one or more persons viewed content or a portion of content such as a television show. However, it may be beneficial to see viewing behavior on an individual level represented by a Boolean outcome (i.e., a person either viewed the content or did not view the content) as opposed to a probabilistic outcome. From a single platform perspective, the probabilistic solution may be easy to understand, but this may not be the case then probabilistic solutions are viewed from a cross-platform perspective. For example, it is not easy to analyze the behavior of an individual whose digital visitations (e.g., website views) are deterministic while his video viewings (e.g., television show views) are probabilistic. Disclosed herein are methods and systems for generating, based on a probability distribution, a deterministic outcome representing whether one or more members of a household viewed a particular portion of content.

In one example, household member data that identifies a plurality of individual members of a household may be accessed. Information that identifies, for each of the plurality of individual members of the household, a probability that a particular portion of a program was viewed by that individual member of the household may also be accessed. A plurality of state spaces may be generated, each of the plurality of state spaces indicating whether or not the particular portion of the program was viewed by each of the plurality of individual members of the household. In addition, a probability distribution may be generated that represents, for each of the plurality of state spaces, a probability that the particular portion of the program was viewed by the plurality of individual members of the household represented by the state space. Based on a simulation (e.g., a Monte Carlo simulation) of the generated probability distribution, a plurality of possible viewership scenarios may be determined, each of the plurality of possible viewership scenarios corresponding to one of the state spaces. Then, one of the plurality of viewership scenarios may be selected, and a report may be generated that identifies, for the selected viewership scenario, each of the individual members of the household and an indication of whether the particular portion of the program was viewed by each of the individual members of the household.

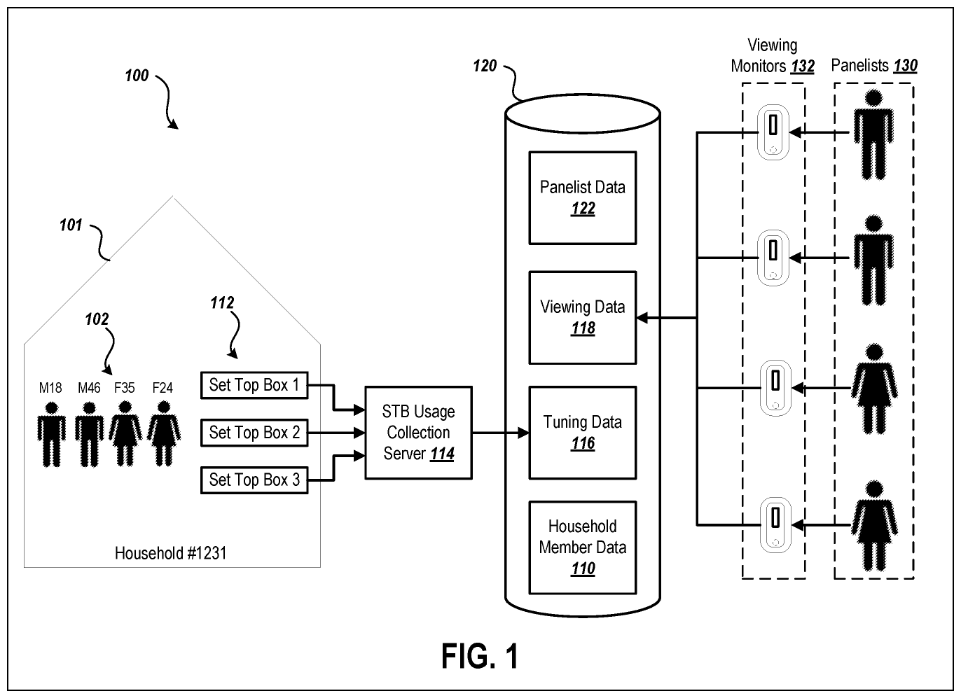

FIG. 1 illustrates an example of a system 100 in which television viewership information may be collected and processed to determine audience measurement data. The system 100 includes a number of households, such as household 101, that includes one or more set top boxes 112 for viewing television programs. The set top boxes 112 record data for tuning events (e.g., viewing events), which may represent a particular television network or program being watched at a particular time. The set top boxes 112 may report these tuning events to a set top box usage collection server 114, which may store tuning data 116 representing these tuning events in a database or other storage 120. In addition to tuning events, the tuning data 116 may include data to identify the household 101 and set top box 112, stream control data, data representing content recorded by the set top box 112, programs ordered on the set top box 112, and data about when the set top box 112 was on or off. Other data about the status of the set top box 112 and user interaction with the set top box 112 may also be recorded and included in tuning data 116.

The household 101 includes one or more members 102 that use the set-top boxes to watch television. These members 102 may be associated with demographics, such as age and gender, and these demographics may be collected and stored in storage 120 or another storage as household member data 110. In the example shown, the household 101 includes four members 102: an 18-year-old male, a 24-year-old female, a 35-year-old female, and a 46-year-old male. Their specific age and gender may be stored in household member data 110, or the members may instead be associated with demographic groups. For example, each member 102 may be associated with an age group (for example: 18-24, 25-34, 35-44, 45-54, 55-64, or 65+), rather than specific age. This information may also be stored in the household member data 110. Other demographics may be collected, such as occupation, income, or ethnicity. In addition, a geographic area or location for the household 101 may be stored in the household member data 110. In some cases, the geographic area or location for the household 101 may be stored as a demographic attribute of the individual members of the household.

The demographic information for the household members 102 may be collected in a number of ways. For example, the household 101 may be recruited to be part of a television viewing panel that is used to determine television viewership data. Once the household 101 is recruited, the demographic information may be collected as part of a registration process.

In another example, the household 101 may be a part of, or recruited into, an Internet usage panel that is used to determine Internet usage. Demographic information of the household members 102 may be collected when the household 101 is registered to be part of the Internet usage panel. As part of the Internet usage panel, the household 101 may have a panel application installed on one or more client systems in the household. The panel application may collect internet usage data to send to an internet usage collection server. In some implementations, the internet usage data could be used to infer information about household member 102, such as by comparing internet content accessed by each member 102 with demographic or other information about users accessing the same content. Other methods may be used to capture or confirm information about members 102 of the household 101, such as survey data or data captured from other household behaviors, or data provided by third party services that attempt to determine demographic data of household members 102.

The system 100 includes a plurality of panelists 130. The panelists 130 may be persons who have provided demographic and other information about themselves, and who opted to have their television viewing behavior monitored. The panelist data 122 stored in the data storage 120 includes the demographic and other information provided by or otherwise obtained from the panelists 130. In some cases, the panelists 130 may be associated with households having associated information, such as household size, household roster, and other information, which may be included in panelist data 122. In some implementations, the viewing data 118 may represent viewing data from panelists 130 associated with households including only other panelists, such that a complete representation of all television viewing within the household is included in the viewing data 118.

In some implementations, the viewing data 118, unlike the tuning data 116, may represent person-level viewing activity for the individual panelists 130. For example, a television viewing event in the viewing data 118 may represent a particular panelist 130 watching a television program for a period of time, as opposed to the tuning data 116, which may represent the television program being watched in the household for a period of time, but may not represent which of the individual members of the household watched the program.

Each of the panelists 130 is associated with a viewing monitor 132. In some cases, the viewing monitors 132 may be portable computing devices carried by each of the panelists 130 that monitor television viewing by the panelist carrying the device. For example, the viewing monitors 132 may be devices operable to capture and analyze sound information to determine if the panelist 130 is watching a particular television program. In some cases, the viewing monitors 132 may extract encoded signals from the sound information identifying the particular television program being watched by the panelist 130. The viewing monitors 132 may also identify the particular television program from the sound information using other mechanisms, such as, for example, by generating acoustic fingerprint from the sound information in querying a database mapping known acoustic fingerprints to television programs. In some implementations, the viewing monitors 132 may monitor other types of information to determine a television program being watched by the panelist 130, such as, for example, video information, radio frequency (RF) signals, infrared (IR) signals, or other information.

The viewing monitors 132 produce viewing data 118 representing viewing activity by the panelists 130. In some implementations, the viewing monitors 132 may provide viewing data 118 directly to the data storage 120. The viewing monitors 132 may also provide the viewing data 118 to a separate collection server or set of servers, and the viewing data 118 may be acquired by or otherwise stored in the data storage 120. In some implementations, the viewing data 118 includes information regarding television viewing events, such as, for example, a television program being watched, a television network, an entity operating the television network, a start time and stop time for the television viewing event, an identifier of the panelist 130 associated with the television viewing event, or other information.

When reporting tuning events, the set top boxes 112 may not be able to directly report the particular household member or members 102 associated with each tuning event. For example, in some implementations, the tuning data 116 may include episode viewership for the household 101, but may not include a breakdown of the viewership of individual members 102 of the household 101. As described further below, the household member data 110, tuning data 116, viewing data 118, and panelist data 122 may be used to determine, for a given program, values for members 102 of the household 101 that represent the probability that the corresponding member 102 watched the program, as well as to project a number of watched minutes for the viewing event for each individual member 102 of the household 101. These values can be aggregated for various demographic groups in order to generate demographic viewership data for the episode, program, or network.

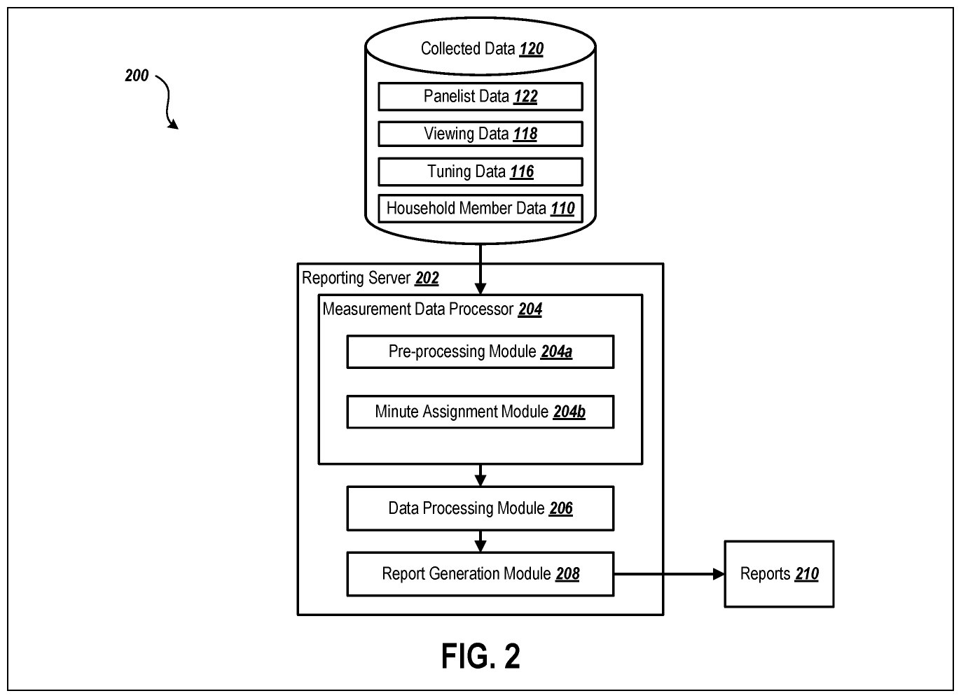

FIG. 2 illustrates an example of a system in which person-level viewing data can be used to generate projected person-level viewing data from household-level tuning data through demographic attribution. The system 200 includes a reporting server 202. The reporting server 202 may be implemented using, for example, a general-purpose computer capable of responding to and executing instructions in a defined manner, a personal computer, a special-purpose computer, a workstation, a server, or a mobile device. The reporting server 202 may receive instructions from, for example, a software application, a program, a piece of code, a device, a computer, a computer system, or a combination thereof, which independently or collectively direct operations. The instructions may be embodied permanently or temporarily in any type of machine, component, equipment, or other physical storage medium that is capable of being used by the reporting server 202.

The reporting server 202 executes instructions that implement a measurement data processor 204, a data processing module 206, and a report generation module 208. The measurement data processor 204 includes a pre-processing module 204a and a minute assignment module 204b. The measurement data processor 204 and report generation module 208 may be operable to generate viewership data based on the household member data 110, tuning data, 116, viewing data 118, and panelist data 122 and use that data to generate one or more viewership reports 210 that include information regarding episode-level, program-level, network-level, or entity-level viewership.

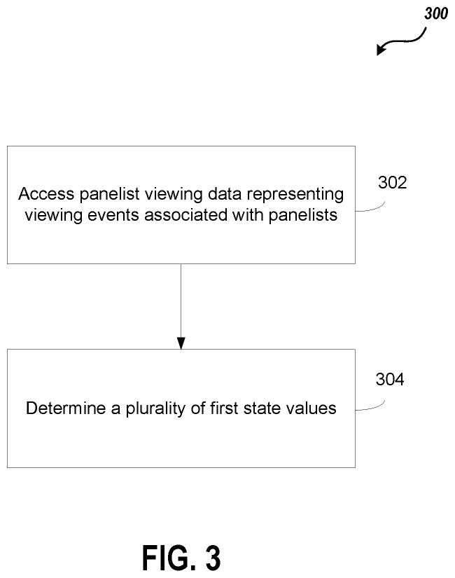

FIG. 3 is a flow diagram illustrating an example process 300 for determining whether a particular portion (e.g., one minute) of a program was watched or not watched by one or more panelists 130. The following describes the process 300 as being performed by components of the reporting server 202 with respect to data associated with the panelists 130. However, the process 300 may be performed by other systems or system configurations and implemented with respect to other members of the viewing audience.

At step 302, the pre-processing module 204a accesses a portion of the collected data 201, including the viewing data 118 and the panelist data 122. The pre-processing module 204a may perform one or more pre-processing functions on the viewing data 118 and the panelist data 122 as appropriate. In some cases, the pre-processing module 204a may identify particular elements of the viewing data 118, such as age category, gender, race, occupation, geographic area, or other elements associated with the panelists.

In some cases, the pre-processing module 204a may sort the viewing data 118 into particular demographic categories based on the particular panelist 130 associated with each viewing event in the viewing data 118. In some cases, the pre-processing module 204a may examine the demographic distribution of the panelists 130 associated with the viewing data 118, and may apply weighting factors to the viewing data 118 to correct any bias in the demographics of the panelists. For example, if the panelists 130 include 80% females and 20% males, the pre-processing module 204a may down-weight the data associated with the female panelists and up-weight the data associated with the male panelists to correct for the gender bias in the sample. This gender bias is indicated by the demographics of the sample being dissimilar to the demographics of the population as a whole (i.e., an 80% female sample may not be representative of the overall population, which is roughly 50% female).

In some implementations, the viewing event may be associated with a program, such as a particular episode of a television program. In some implementations, the television viewing event may not be associated with a particular program but may be associated with tuning data 116 such as a date, time, and television network.

At step 304, the minute assignment module 204b may determine a plurality of state values corresponding to a particular portion of the program and representing whether the program was watched or not watched for the particular portion of the program by a given one of the panelist members. The particular portion of the program may correspond to a one minute duration of the program. The plurality of state values may include a first value associated with the program being watched for the particular minute of the program and a second value associated with the program not being watched for the particular minute of the program.

In order to determine the plurality of state values, a model may be constructed by considering each minute as a state. A person at minute t must be in one of the states, either “watch” (W) or “not watch” (NW) for each of a plurality of states S=s₁, s₂, . . . s_{L}. The process may begin in one of these states and may change from one minute to another. If the viewer is currently in state then it may move to state sⱼ with a probability denoted by p_{i,j}. This is also known as the “transition probability.” The transition probability from one state to another is not dependent on which state the chain was in before the current state. Each viewer has his/her own transition probability p_{t,t+1} to jump from minute sₜ to minute sₜ₊₁. By estimating the transition probabilities, the probability of the program being watched (W) or not watched (NW) for each particular minute of the program can be calculated.

The plurality of state values may be used to determine a total number of watched states (L) and a number of consecutive watched states (N) by a household member. The total number of minutes of a program watched by a given household member may be represented by the variable L. The variable L may also be represented as the number of transitions from a watched state (W) to a watched state (W) or from a watched state (W) to a not watched state (NW). The number of continuous watched states by a household member may be represented by the variable N. In other words, the variable N may represent the number of times where sₜ< >sₜ₊₁.

An example nine minute television program may be represented as follows:

(W) (W) (W) (NW) (W) (NW) (NW) (W) (W).

Each of the state values of the program may correspond to a particular minute of the program. Thus, the program may have been watched by a given member of the household for the first three minutes of the program, not watched for the fourth minute of the program, watched for the fifth minute of the program, not watched for the sixth and seventh minutes of the program, and watched for the eighth and ninth minutes of the program. Thus, it can be determined that L=6 since there are a total of six watched states out of the nine total states. In addition, we can determine that N=3 since there are three consecutive series of watched states (e.g., a first series of three watched states, a second series of one watched state, and a third series of two watched states).

TABLE 1
Example Transition Matrix

| #transitions | watch | not watch | row_sum |
|---|---|---|---|
| watch | L-N | N | L |
| not watch | N | hh_minutes + | hh_minutes + |
| | | hh_session − N − L | hh_session − L |

The values of L and N may be used to further predict the transition probability (p) that the show was watched at minute sₜ and was watched again at next minute sₜ₊₁ and also to predict the transition probability (q) that the show was not watched at minute sₜ and was not watched again at next minute sₜ₊₁. A probability matrix may be generated as follows using the values of p and q:

TABLE 2
Example Probability Matrix

| prob( ) | watch | not watch |
|---|---|---|
| watch | p | 1-p |
| not watch | 1-q | q |

If minute sₜ=watch and minute sₜ+1=watch, then we may denote the transition probability p_{t,t+1}=p. If minute sₜ=not watch and minute sₜ+1=not watch, then we may denote the transition probability p_{t,t+1}=q. The values of p and q may also be defined as follows:

p=1−N/L, and

q=1−N/(hhMinutes+hhSession−L).

There may be a number of boundary conditions associated with the model. Example boundary conditions include but are not limited to the following:

Any minute watched by a member of the household is a minute watched by that household. Therefore, person level viewing minutes should always be less than or equal to the household viewing minutes (Li<=household minutes);

In the application, live viewing and playback viewing may be modeled separately. The model assumes that even with playback, the household minutes value may be less than or equal to the entire runtime of the program (household minutes <=R);

With the possibility of multiple members of the family viewing together (co-viewing behavior), each minute may be counted multiple times on the person level and counted only once on the household level. This means that the household minutes value is always less than or equal to the sum of person minutes (household minutes <=sum(Lᵢ));

Any transition from watching to not watching may be counted as starting a new session (count towards N) and any transition from watching to watching or watching to not watching is counted as already viewing the previous minute (count towards L). Therefore, we have 0<=Ni<=Li;

Consecutive sessions may be combined (Ni+Li<=R+1);

The household session may be less than or equal to the total number of overlapping sessions for each person in the household (householdSession<=sum(Ni));

If the show is viewed in full duration, then p=1 and q=0. Conversely, if the shows is not viewed at all, then p=0 and q=1.

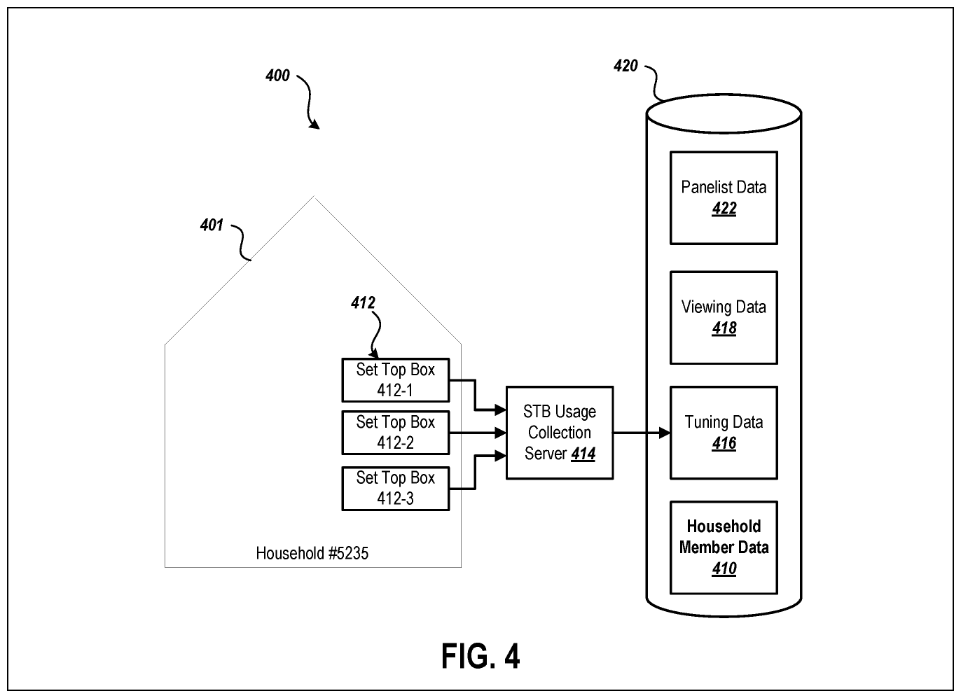

FIG. 4 illustrates an example of a system 400 in which television viewership information may be collected and processed to determine audience measurement data for non-rostered households. Similarly to the system 100 of FIG. 1, system 400 includes a household 401 including set top boxes 412 for viewing television content. The set top boxes 412 report tuning events to the STB collection server 414, which stores the tuning events as tuning data 416 in data store 420. The data store 420 also includes household member data 410 having information for individual members of households. In some cases, the household 401 may not be associated with information regarding individual members of the household, making household 401 a “non-rostered” household.

The data store 420 may include viewing data 418. In some cases, the viewing data 418 may include observed person-level viewing data from one or more panelists associated with panelist data 422, such as described relative to FIG. 1. The viewing data 418 may also include projected person-level viewing data calculated for tuning data 416 for rostered households associated with individual member information in the household member data 410 (e.g., household 101 from FIG. 1).

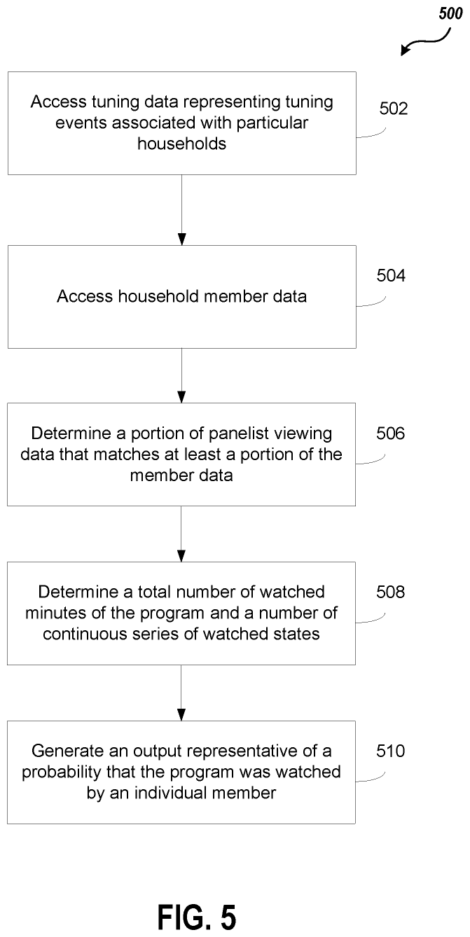

FIG. 5 is a flow diagram illustrating an example process 500 for determining a probability that an individual household member will watch a particular portion of a program.

The following describes the process 500 as being performed by components of the reporting server 202 with respect to data associated with the household 101. However, the process 500 may be performed by other systems or system configurations and implemented with respect to other members of the viewing audience.

At step 502, the pre-processing module 204a accesses the collected data 201, including household member data 410, tuning data 416, viewing data 418, and panelist data 422. The pre-processing module 204a may perform one or more pre-processing functions on the household member data 410, tuning data 416, viewing data 418, and panelist data 422 as appropriate.

At step 504, the pre-processing module 204a may identify particular elements of the household member data 410 for use in comparison with the panelist data 422 associated with the viewing data 418, such as age category, gender, race, occupation, geographic area, or other elements. Information about the household as a whole, such as household size or income, may also be identified for use. Each household member may be identified by one or more demographic dimensions relevant to the particular application of the demographic attribution model.

In some cases, the pre-processing module 204a may sort the household member data 410 into particular demographic categories for demographic attribution. The pre-processing module 204a may also sort the viewing data 418 into particular demographic categories based on the particular panelist 130 associated with each viewing event in the viewing data 418. The pre-processing module 204a may identify the particular program associated with a household event within the tuning data 416. In some cases, the pre-processing module 204a may examine the demographic distribution of the panelists 130 associated with the viewing data 418 and may apply weighting factors to the viewing data 418 to correct any bias in the demographics of the panelists, as discussed above in connection with FIG. 3.

In some implementations, the pre-processing module may extract the tuning event data for the television viewing event from a larger collection of tuning data 416 involving multiple tuning events. In some implementations, other relevant tuning events may also be extracted (such as simultaneous events as further described below).

In some implementations, the television viewing event may be associated with a particular episode of a television program. In some implementations, the television viewing event may not be associated with a particular program but may be associated with tuning data 416 such as a date, time, and television network.

The pre-processing module 204a may extract the viewing data 418 for demographic groups matching the individual members of the household 101 and demographic groups from households that match the household 101 as a whole. For the example of the household 101 as shown in FIG. 1, the pre-processing module 204a may extract the viewing data for 18-year-old males in households with four people, 24-year-old females in households with four people, 35-year-old females in households with four people, and 46-year-old males in households with four people.

The viewing data 418 may be for the viewership of television viewing events sharing one or more characteristics with the television viewing event represented by the tuning data 416. For example, where the tuning data 416 represents a television viewing event represented by a particular episode of a television program, the viewing data 418 may be for the viewership of the television program by the panelists 130. If the television viewing event is represented by a date, time, and network, the viewing data 418 may be for the viewership of the network at the date and time by the panelists 130.

At step 506, a portion of the panelist viewing data whose panelist information matches at least a portion of the member data of the one or more individual members of the household may be determined.

In one example, the measurement data processor 204 accesses the tuning data 416 and the person-level viewing data 418. The tuning data 416 may include tuning data for rostered households and non-rostered households. In some cases, the tuning data 416 includes a particular television program watched during each viewing event and a household minutes value representing a number of minutes the particular household watched the particular television program during each viewing event. The person-level viewing data 418 may represent television viewing events associated with panelist members of other households different than the particular household, and may include a particular television program watched during the viewing event and a panelist minutes value representing a number of minutes the particular panelist member watched the particular television program.

The measurement data processor 204 identifies group subsets including tuning data 416 having matching values for a grouping criteria including attributes included in the tuning data and the person-level viewing data. For example, the measurement data processor 204 may identify group subsets of tuning data 416 for particular geographic areas, such that each group subset includes tuning data for households in that region (e.g., a group subset for Texas, another group subset for New York, etc.). The grouping criteria for the group subsets may also include other criteria or combinations of criteria, including number of set-top-boxes, household size, and other criteria.

For each particular group subset identified, the measurement data processor 204 identifies matching person-level viewing data including person-level viewing data that matches values for group criteria associated with the particular group subset. For example, for a group subset for the geographic area “Texas,” the measurement data processor 204 may identify matching person-level viewing from the viewing data 418 also associated with “Texas.”

The measurement data processor 204 calculates a unique viewers value for the group subset based on the matching person-level viewing data. In some cases, the unique viewers value represents an estimated number of individual members of households associated with the tuning data included in the group subset that watched the particular television program. In some implementations, calculating the unique viewers value includes determining a members per household number for the matching person-level viewing data, wherein the unique viewers value for the particular group subset is based at least in part on the members per household number.

Calculating the unique viewers value may include calculating a set of demographic unique viewers values, wherein each demographic unique viewers values is associated with a particular one of a plurality of demographic groups and represents an estimated number of individual members in the particular demographic group from households associated with the tuning data included in the group subset that watched the particular television program.

For example, to calculate a unique viewers value for a show called “SNL,” the measurement data processor 204 may determine a members per household number of 2.5 for Texas by determining the average number of persons in households represented by the viewing data 418 (e.g., by dividing the total number of persons in all households by the number of households). The measurement data processor 204 may also determine that 80% of viewers represented by the viewing data 418 watched SNL. If the non-rostered tuning data represents 10 households, the measurement data processor 204 may estimate that these households include 25 individual members (e.g., 10 households×2.5 members per household), and that 20 of them watched SNL based on 80% viewership. If the viewing data shows that viewers for SNL were 60% male and 40% female, the measurement data processor 204 may estimate that 12 males (60% of the 20 estimated viewers) and 8 females (40% of the 20 estimated viewers) watched SNL in the 10 households.

The measurement data processor 204 calculates a person-level minutes value for the group subset based on the matching person-level viewing data 610A. A person-level minutes value for an advertisement shown during the television program may also be determined, as shown in 610B. In some implementations, the person-level minutes value represents an estimated number of minutes individual members of households associated with the tuning data included in the group subset watched the particular television program. In some cases, calculating the person-level minutes value for the group subset includes determining a co-viewing factor for the matching person-level viewing data representing a ratio of household-level viewing minutes to person-level viewing minutes for the group subset, wherein the person-level minutes value for the group subset is based at least in part on the co-viewing factor.

At step 508, for each of the individual members of the household, a total number of watched minutes of the program by the individual member of the household and a number of continuous series of watched states of the program by the individual member of the household may be determined.

This process may begin by estimating the value of L for the tuning data 416 associated with the household member data 410. The viewing minutes L in the tuning data 416 may be determined based on the mixture of two distributions: a quasi Poisson (m1) distribution and a LogNormal distribution (m2). The two distributions may be separated using the parameter π, defined as the probability of picking the LogNormal (m2) distribution. Using the model described herein, a number can be randomized between [0,1]. If the result is greater than π, the Poisson distribution may be used. Otherwise, the LogNormal distribution may be used.

The value of L may be determined using the following formula:

L=(1−π)*m1+(π)*m2,

where

m1=Poisson(λ), and

m2=hhMinutes*LogNormal(μ,σ2).

The parameter π may be modeled through the following weighted generalized linear model. Since mixture weight parameter π is an indicator that L falls into the lognormal portion of the mixture distribution, and this event is discrete and binary, the event follows a binomial distribution.

glm(hhSize+hhMinutes+GenderAge+DayBin+HourBin+Genre+ContentRuntime+NetworkType,family=binomial(link=“logit”),weights=ceil(TrainingSetPersonWeights).

To model the mixture distribution parameter π and the Poisson distribution parameter A, a generalized linear model may be used with weights to correct for sample bias in the training set. Demographic information may be used to correct the sample bias towards the population target, including gender, age, presence of children, household size, race, ethnicity, income, etc. The generalized linear model may also include certain pieces of demographic information, as well as the household tuning behavior (such as household minutes), together with the program information (such as genre, content runtime, broadcast or cable, etc.).

Assuming that L falls into the m1 part of the distribution with probability (1−π), then the Poisson distribution can be estimated using the following formula:

glm(hhSize+hhMinutes+GenderAge+Genre+ContentRuntime+NetworkType,family=quasipoisson(link=“log”),weights=cell(TrainingSetPersonWeights).

As for the lognormal distribution, we can fit for the shape and scale parameters (σ and μ) using a generalized additive model weighted by the aforementioned panelists' weights. Assuming that L falls into the m2 part of the distribution with probability π, then the LogNormal distribution can be estimated using the following formula:

gamlss(hhSize+hhMinutes+GenderAge+Genre+ContentRuntime+NetworkType,family=LOGNO2,weights=ceil(TrainingSetPersonWeights).

Unlike the L model, the empirical distribution of N shows a single peak distribution instead of a bi-modal distribution. Therefore, it's sufficient to model N using a Poisson distribution with a weighted generalized linear model using the following formula:

glm(hhSession+log(hhMinutes/ContentRuntime)+GenderAge+Genre,family=quasipoisson(link=“log”),weights=ceil(TrainingSetPersonWeights).

After the values of L and N have been determined, the values of p and q may be calculated as follows:

p=1−N/L, and

q=1−N/(hhMinutes+hhSession−L).

Once the values of p and q have been determined, we can estimate the probability that a given person in the household watched the television show. This may be determined using the following formula:

UVᵢ=1−Pr(X₀=NW)·Pr(NW→NW)^{hhminutes}=1−qᵢ^{hhminutes}.

and

ViewingMinuteᵢ=Li

In other words, the probability of a family member watching at least one minute of the program in a household where a tuning event of this program is observed is equal to one minus the probability that this member doesn't watch any minute of show at all. which can be formally written as this member start from not watching at state zero and continue to go from not watching to not watching for the entire time when there are other member in this household watching the show.

Further, the probability that a particular household watched the program may be calculated using the following formula:

CVF_{HH}=(Σ_{i∈HH}Lᵢ)/HHₘᵢₙᵤₜₑₛ.

For each minute t that is marked as “watching,” it can be determined that the probability of watching minute t where m is the m^{th} minute in the session sⱼ is:

$$\begin{matrix}{ViewingMinute}_{t} := ρ t \\ = Pr ( {X}_{t} = W ) \\ = 0 ( if {HH}_{t} = NW ) , otherwise \text{:}\end{matrix}$$

At step 510, the report generation module 208 may generate viewership reports 210 based on the above-determined viewership data. These reports may include data at any level of aggregation, and may be specified by a user. Reports may include the viewership data of various demographic groups as estimated through the use of demographic attribution. Entities may request particular demographic data and data at a particular level of aggregation.

For example, a program-level report may show that a particular portion of a program has been watched by 12% of males ages 18-24. A network-level report may show that 45% of viewers of a particular network are females above age 40. An entity-level report may show that 57% of males and 25% of females watched at least a portion of the entity's sports networks during the time period representing this year's regular baseball season.

Because a household may have more than one set top box and more than one display device, at times there may be more than one program episode being viewed at a time by members of a household. In some implementations, the existence of more than one program episode being viewed at the same time in a household may affect the fractional values determined for members of that household for one or both of the viewing events.

In some implementations, the pre-processing module 204a identifies simultaneous events associated with the same household generated by set top boxes. Simultaneous events are those that include at least some overlap in the times in which the events are shown. In some cases, simultaneous events may have to have at least a threshold amount of overlap to be considered simultaneous; that is, nominal overlap between the first and last minutes of events that are primarily at different times may not be identified as simultaneous.

The methods described in connection with FIGS. 3-5 may be used for determining a probability that an individual household member will watch a particular portion of a program. However, as discussed above, it may be beneficial to represent viewing behavior on an individual level as a Boolean outcome (e.g., a household member either viewed a portion of the content or did not view the portion of the content) as opposed to a probabilistic outcome (e.g., there is a 35% probability that the household member viewed the content).

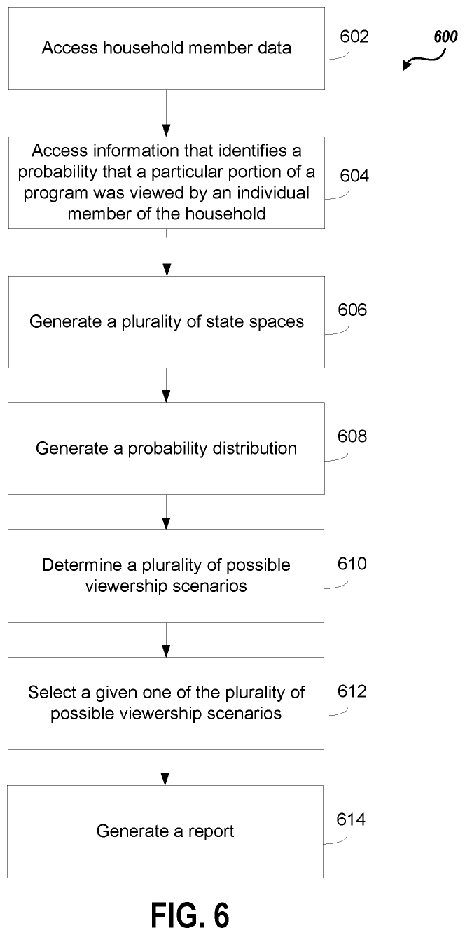

FIG. 6 shows an example method 600 for generating a deterministic output for content viewership based on a probability model.

At step 602, the pre-processing module 204a may access household member data 110. The household member data 110 may identify a plurality of individual members 102 of a household 101. These household members 1102 may be associated with certain demographics, such as age and gender, and these demographics may be collected and stored as household member data 110. In one example, the household 101 may include five individual members 102. The individual members 102 may be identified as follows: 14-year-old male (Person 1), 19-year-old female (Person 2), 22-year-old male (Person 3), 46-year-old female (Person 4), and 48-year old male (Person 5). The terms “person” and “member” may be used interchangeably herein. It is understood that the demographic information listed above is not limited to age and gender, and that the household member data 110 may include data other than demographic data, such as income data and location data.

At step 604, the pre-processing module 204a may access information that identifies, for one or more of the plurality of individual members 102 of the household 101, a probability that a particular portion of a program was viewed by that individual member 102 of the household 101. The information may be based on at least one of the panelist data 122 and the household member data 110. In one example, the information may be determined based on one or more of the steps discussed above in connection with FIGS. 3-5. In another example, the measurement data processor 204 may access the information, which may be stored in a table of a device associated with the system 200. In yet another example, the pre-processing module may receive the information from one or more other devices not associated with the system 200. The information may be represented as follows:

TABLE 3
Individual Viewer Probability Information

| Person | Viewership Probability |
|---|---|
| Person 1 | 0.5773 |
| Person 2 | 0.2735 |
| Person 3 | 0.9335 |
| Person 4 | 0.2652 |
| Person 5 | 0.7845 |

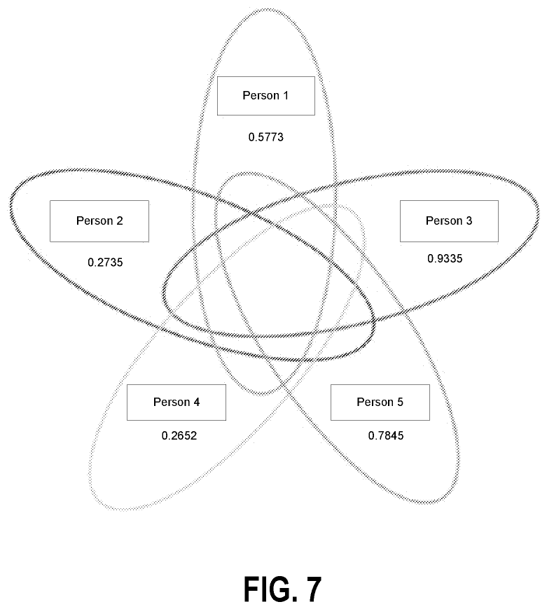

Thus, in this example, the probability of Person 1 (irrespective of any of the other persons) viewing the portion of the content is 0.5773 (e.g., a 57.73% probability), the probability of Person 2 (irrespective of any of the other persons) viewing the portion of the content is 0.2735 (e.g., a 27.35% probability), etc. This information may additionally or alternatively be represented in a Venn diagram, as shown in the example of FIG. 7.

At step 606, the data processing module 206 may generate or determine a plurality of state spaces. Each of the plurality of state spaces may include an indication of whether or not the particular portion of the program was viewed by each of the plurality of individual members 102 of the household 101. This indication may be represented by one or more state values. The state value(s) may include one of a first state value indicating that the particular portion of the program was viewed by the individual member 102 of the household 101 and a second state value indicating that the particular portion of the program was not viewed by the individual member 102 of the household 101. In the example that the household includes five members (e.g., persons), the data processing module 206 may generate a total of 32 state spaces (e.g., five household members each with a binary input). Each of the 32 state spaces may indicate whether each of the five members of the household represented by that state space viewed the particular portion of the program.

In an example, a first one of the state spaces may indicate that the particular portion of the program was viewed by person 1 and was not viewed by any of person 2, person 3, person 4, or person 5. A second one of the state spaces may indicate that the particular portion of the program was viewed by person 1 and person 2 and was not viewed by any of person 3, person 4, or person 5. A third one of the state spaces may indicate that the particular portion of the program was viewed by person 1 and person 3 and was not viewed by any of person 2, person 4, or person 5. A fourth one of the state spaces may indicate that the particular portion of the program was viewed by each of person 1, person 2, person 3, person 4, and person 5. The state spaces may be represented using binary logic, with “0” representing that the particular portion of the program was not watched by an individual person and “1” representing that the particular portion of the program was watched by an individual person. This data may be summarized in a table, as shown below:

TABLE 4
Example State Spaces

| | Person 1 | Person 2 | Person 3 | Person 4 | Person 5 |
|---|---|---|---|---|---|
| State Space 1 | 1 | 0 | 0 | 0 | 0 |
| State Space 2 | 1 | 1 | 0 | 0 | 0 |
| State Space 3 | 1 | 0 | 1 | 0 | 0 |
| State Space 4 | 1 | 1 | 1 | 1 | 1 |

While this example shows a representation of four separate state spaces, it is understood that the data processing module 206 may generate any number of state spaces. In a typical example, the data processing module 206 may generate a number of state spaces corresponding to the total number of viewership combinations for the plurality of viewers (e.g., 32 state spaces).

At step 608, the data processing module 206 may generate a probability distribution that represents, for each of the plurality of state spaces, a probability that the particular portion of the program was viewed by the plurality of individual members 102 of the household 101 represented by the state space. The probability distribution may be determined and represented as follows:

P(1 viewer present: person1 viewing alone)=p1*(1−p2)*(1−p3)*(1−p4)*(1−p5)=0.5773*(1−0.2735)*(1−0.9335)*(1−0.2652)*(1−0.7845)=0.0044

P(2 viewers present: person1 and person2)=p1*p2*(1−p3)*(1−p4)*(1−p5)=0.5773*0.2735*(1−0.9335)*(1−0.2652)*(1−0.7845)=0.001662635

P(2 viewers present: person1 and person3)=p1*(1−p2)*p3*(1−p4)*(1−p5)=0.5773*(1−0.2735)*0.9335*(1−0.2652)*(1−0.7845)=0.061996607

P(5 viewers present: all persons view together)=p1*p2*p3*p4*p5=0.5773*0.2735*0.9335*0.2652*0.7845=0.030665

In one example, generating the probability distribution may include processing one or more of the plurality of state spaces in parallel. Similar to step 606, the data processing module 206 may be configured to determine a probability distribution for each of the total number of viewership combinations for the plurality of individual members 102. Thus, in the example that there are five household members capable of being in either a “watched” state or a “not watched” state for a particular portion of the program, generating a probability distribution may comprise generating, for each of the 32 possible combinations of household members (e.g., a given state space), a probability that the particular portion of the program was viewed by that combination of household members.

At step 610, the data processing module 206 may determine a plurality of possible viewership scenarios. Each of the plurality of possible viewership scenarios may correspond to a given one of the state spaces. The plurality of possible viewership scenarios may be determined based on a simulation of the generated probability distribution. In one example, the simulation may be a Monte Carlo simulation where the number of possible viewership scenarios exceeds (or greatly exceeds) the number of possible state spaces. A typical Monte Carlo simulation may generate hundreds or thousands of results such that the probability of randomly selecting a given one of the possible viewership scenarios generally corresponds to the probability of the one or more members of the household viewing the particular portion of the content as represented by the probability distribution.

At step 612, the data processing module 206 may select a given one of the plurality of possible viewership scenarios. In one example, the data processing module 206 may randomly select a given one of the plurality of possible viewership scenarios based on the simulation of the plurality of possible viewership scenarios. Since the simulation may create a large sample size of data, the odds of randomly selecting a given one of the viewership scenarios may generally correspond to the probability of the one or more members of the household viewing the particular portion of the content as represented by the probability distribution. For example, the probability of selecting a viewership scenario representing that Person 1 and Person 3 viewed the particular portion of the program may generally be twice as likely as selecting a viewership scenario representing that all of Person 1, Person 2, Person 3, Person 4 and Person 5 viewed the particular portion of the program. This corresponds generally to the data represented in the probability distribution. For example, as calculated above: P(2 viewers present: person1 and person3)=0.061996607 and P(5 viewers present: all persons view together)=0.030665.

At step 612, the report generation module may generate a report that identifies, for the selected viewership scenario, each of the individual members of the household and an indication of whether the particular portion of the program was viewed by each of the individual members of the household. The report may be represented as a table. In addition to the viewership information, the table may include information including but not limited to: an identifier of the person, an identifier of the set-top box, an IP address that was used to access the content, a household identifier, a household size, and a probability that the individual member would view the content on their own. In an example where a viewing scenario corresponding to an output that Person 1, Person 3, Person 4 and Person 5 viewed the particular portion of the content, the table may be represented as follows:

TABLE 5
Example Viewership Report

| | | Household | Household | Individual | |
|---|---|---|---|---|---|
| Person ID | IP Address | ID | Size | Probability | State |
| 2581485299 | 724518125 | 4411747481 | 5 | 0.5773 | 1 |
| 2581485300 | 724518125 | 4411747481 | 5 | 0.2735 | 0 |
| 2581485301 | 724518125 | 4411747481 | 5 | 0.9335 | 1 |
| 2581485302 | 724518125 | 4411747481 | 5 | 0.2652 | 1 |
| 2581485303 | 724518125 | 4411747481 | 5 | 0.7845 | 1 |

Although specific examples using various equations of probability are described herein, the methods described herein can be used with a variety of probability and statistical techniques and are not limited to only the equations and examples shown.

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device, in machine-readable storage medium, in a computer-readable storage device or, in computer-readable storage medium for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques can be performed by one or more programmable processors executing a computer program to perform functions of the techniques by operating on input data and generating output. Method steps can also be performed by, and apparatus of the techniques can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, such as, magnetic, magneto-optical disks, or optical disks. Information carriers suitable for embodying computer program instructions and data include all forms of non-volatile memory, including by way of example semiconductor memory devices, such as, EPROM, EEPROM, and flash memory devices; magnetic disks, such as, internal hard disks or removable disks; magneto-optical disks; and CD-ROM and DVD-ROM disks. The processor and the memory can be supplemented by, or incorporated in special purpose logic circuitry.

A number of implementations of the techniques have been described. Nevertheless, it will be understood that various modifications may be made. For example, useful results still could be achieved if steps of the disclosed techniques were performed in a different order and/or if components in the disclosed systems were combined in a different manner and/or replaced or supplemented by other components.

1. A computer-implemented method, comprising:
accessing household member data that identifies a plurality of individual members of a household;
accessing information that identifies, for each of the plurality of individual members of the household, a probability that a particular portion of content was viewed by that individual member of the household;
generating a plurality of state spaces, each of the plurality of state spaces comprising an indication of whether or not the particular portion of the content was viewed by each of the plurality of individual members of the household;
generating a probability distribution that represents, for each of the plurality of state spaces, a probability that the particular portion of the content was viewed by the plurality of individual members of the household represented by the state space;
determining, based on a simulation of the generated probability distribution, a plurality of possible viewership scenarios, each of the plurality of possible viewership scenarios corresponding to one of the state spaces;
selecting one of the plurality of possible viewership scenarios; and
generating a report that identifies, for the selected viewership scenario and for each of the individual members of the household, a Boolean output indicating whether or not the particular portion of the content was viewed by the individual member of the household.

2. The method of claim 1, wherein the simulation is a Monte Carlo simulation.

3. The method of claim 1, wherein each of the plurality of state spaces comprises, for each of the plurality of individual members of the household, a state value corresponding to whether or not the particular portion of the content was viewed by the individual member of the household.

4. The method of claim 3, wherein the state value is one of a first state value indicating that the particular portion of the content was viewed by the individual member of the household and a second state value indicating that the particular portion of the content was not viewed by the individual member of the household.

5. The method of claim 1, wherein selecting one of the plurality of possible viewership scenarios comprises randomly selecting one of the plurality of possible viewership scenarios.

6. The method of claim 1, wherein the information is based on at least one of panelist viewing data and household member data.

7. The method of claim 6, wherein accessing the information comprises determining, for each of the plurality of individual members of the household, a total number of watched minutes of the particular portion of the content by the individual member of the household and a number of continuous series of watched states of the particular portion of the content by the individual member of the household.

8. The method of claim 1, wherein accessing the information comprises accessing a table that identifies, for each of the plurality of individual members of the household, a probability that the particular portion of the content was viewed by that individual member of the household.

9. The method of claim 1, wherein generating the probability distribution comprises processing one or more of the plurality of state spaces in parallel.

10. The method of claim 1, wherein generating the plurality of state spaces comprises determining all possible intersections between the plurality of individual members of the household.

11. The method of claim 1, wherein the particular portion of the content is a one minute duration of the content.

12. The method of claim 1, wherein the content is at least one of a television program or a movie program.

13. A device comprising a processor and a memory, the memory storing computer executable instructions which, when executed by the processor, cause the device to perform operations comprising:
accessing household member data that identifies a plurality of individual members of a household;
accessing information that identifies, for each of the plurality of individual members of the household, a probability that a particular portion of content was viewed by that individual member of the household;
generating a plurality of state spaces, each of the plurality of state spaces comprising an indication of whether or not the particular portion of the content was viewed by each of the plurality of individual members of the household;
generating a probability distribution that represents, for each of the plurality of state spaces, a probability that the particular portion of the content was viewed by the plurality of individual members of the household represented by the state space;
determining, based on a simulation of the generated probability distribution, a plurality of possible viewership scenarios, each of the plurality of possible viewership scenarios corresponding to one of the state spaces;
selecting one of the plurality of possible viewership scenarios; and
generating a report that identifies, for the selected viewership scenario and for each of the individual members of the household, a Boolean output indicating whether or not the particular portion of the content was viewed by the individual member of the household.

14. The device of claim 13, wherein the simulation is a Monte Carlo simulation.

15. The device of claim 13, wherein each of the plurality of state spaces comprises, for each of the plurality of individual members of the household, a state value corresponding to whether or not the particular portion of the content was viewed by the individual member of the household.

16. The device of claim 15, wherein the state value is one of a first state value indicating that the particular portion of the content was viewed by the individual member of the household and a second state value indicating that the particular portion of the content was not viewed by the individual member of the household.

17. A non-transitory computer-readable storage medium comprising computer-executable instructions which, when executed by a device, cause the device to perform operations comprising:
accessing household member data that identifies a plurality of individual members of a household;
accessing information that identifies, for each of the plurality of individual members of the household, a probability that a particular portion of content was viewed by that individual member of the household;
generating a plurality of state spaces, each of the plurality of state spaces comprising an indication of whether or not the particular portion of the content was viewed by each of the plurality of individual members of the household;
generating a probability distribution that represents, for each of the plurality of state spaces, a probability that the particular portion of the content was viewed by the plurality of individual members of the household represented by the state space;
determining, based on a simulation of the generated probability distribution, a plurality of possible viewership scenarios, each of the plurality of possible viewership scenarios corresponding to one of the state spaces;
selecting one of the plurality of possible viewership scenarios; and
generating a report that identifies, for the selected viewership scenario and for each of the individual members of the household, a Boolean output indicating whether or not the particular portion of the content was viewed by the individual member of the household.

18. The non-transitory computer-readable storage medium of claim 17, wherein the simulation is a Monte Carlo simulation.

19. The non-transitory computer-readable storage medium of claim 17, wherein each of the plurality of state spaces comprises, for each of the plurality of individual members of the household, a state value corresponding to whether or not the particular portion of the content was viewed by the individual member of the household.

20. The non-transitory computer-readable storage medium of claim 19, wherein the state value is one of a first state value indicating that the particular portion of the content was viewed by the individual member of the household and a second state value indicating that the particular portion of the content was not viewed by the individual member of the household.
